(19) United States
(12) Patent Application Publication
(10) Pub. No.: US 2026/0229007 A1
(43) Pub. Date: Aug. 6, 2026

(54) INFORMATION PROCESSING APPARATUS

(71) Applicant: NEC Corporation, Tokyo (JP)

(72) Inventor: Rui ISHIYAMA, Tokyo (JP)

(73) Assignee: NEC Corporation, Tokyo (JP)

(21) Appl. No.: 19/148,023

(22) PCT Filed: Jan. 20, 2023
(86) PCT No.: PCT/JP2023/001749

§ 371 Date: Jul. 15, 2025

(51) Int. Cl. G06V 10/75; G06V 10/72; G06V 10/74

(52) U.S. Cl. CPC G06V 10/751; G06V 10/72; G06V 10/758; G06V 10/761

(57) ABSTRACT

An apparatus first extracts feature points defined by position, scale, orientation and a local descriptor from both an object image and a reference image. The apparatus then compares descriptors to establish tentative point correspondences. For each tentative match, the apparatus votes in a two-dimensional parameter space of scale magnification and rotation angle: each match contributes to an intersection point defined by its scale and rotation sections. A histogram of these votes is built over all intersections. Finally, correct correspondences are selected as those tentative matches that fall into the histogram's highest-vote intersections.

### TECHNICAL FIELD

The present invention relates to an information processing apparatus, an information processing method, and a recording medium.

### BACKGROUND ART

One of the techniques for image matching performed by an information processing apparatus is to compare all feature points of an object image (query image) and individual registered images, obtain a pair of feature points having closest local feature values as corresponding points, and use one having the largest number of corresponding points in the registered images as a matching result. However, in an environment where the local feature value varies significantly by various factors such as lighting and posture changes, many incorrect corresponding points may be obtained. Therefore, various methods have been proposed to remove incorrect corresponding points.

For example, in RANdom SAmple Consensus (RANSAC), a geometric transformation parameter of an image is estimated by randomly selecting a subset from a corresponding point set, and an operation to exclude outliers is repeated many times to select an optimal corresponding point set.

Further, in the method described in Patent Literature 1, for each of the corresponding point pairs that are combinations of tentative corresponding points, a correct set of corresponding points is determined based on all constraints on the consistency of scaling magnification, the consistency of rotation angle, and the consistency of relative positional relation, based on comparison or difference in geometric transformation parameters of the corresponding points.

Further, in the method described in Patent Literature 2, a geometric transformation parameter calculating unit first calculates a geometric transformation parameter for each first corresponding point that is a pair of feature points corresponding to each other in a pair of input images. Then, a pseudo-geometric parameter calculating unit calculates a pseudo-geometric transformation parameter based on the geometric transformation parameter and a second corresponding point different from the first corresponding point. Then, a parameter discretizing unit specifies a discretized section in the geometric transformation space. Then, a voting histogram creating unit creates is a voting histogram by voting on a discretized section of the geometric transformation space for the geometric transformation parameter and the pseudo geometric transformation parameter.

Patent Literature 3 is another literature that describes a technique related to the present invention. In Patent Literature 3, a plurality of image data blocks forming the original image data are precisely joined. To be specific, an overlapping area is extracted when an original image and a reference image related to the acquired image data block are superimposed using a geometric transformation expression T. Then, feature points in the overlapping area of the original image and the reference image are extracted. Then, the corresponding points in the overlapping area of the original image and the reference image corresponding to each feature point are extracted using a geometric transformation expression T. Then, the geometric transformation expression T is generated so that the matching degree of a plurality of feature points and a plurality of corresponding points corresponding thereto becomes highest. Then, the geometric transformation expression T is repeatedly modified while increasing the resolution R step by step until the resolution R reaches the maximum processing resolution.

### CITATION LIST

### Patent Literature

Patent Literature 1: JPWO 2017/006852 A
Patent Literature 2: JP 2016-157268 A
Patent Literature 3: JP 2009-044612 A

### SUMMARY OF INVENTION

### Technical Problem

However, there is a problem that the methods of eliminating the above-described incorrect correspondence points all involve a large amount of information processing. The reason for this is that the RANSAC requires to perform operation to remove outliers repeatedly. Moreover, in the method described in Patent Literature 1, the number of pairs of all tentative corresponding points is enormous. Further, the method described in Patent Literature 2 is for calculating geometric transformation parameters and performing discretization and voting on parameters for not only the first corresponding point but also a second corresponding point different from the first corresponding point. As a result, there is a demand to simply remove incorrect corresponding points.

An object of the present invention is to provide an information processing apparatus that solves the aforementioned problem.

### SOLUTION TO PROBLEM

An information processing apparatus, according to one aspect of the present invention, is configured to include
an object image acquiring means for acquiring an image obtained by capturing a face of an object as an object image;
a reference image acquiring means for acquiring an image obtained by capturing a face of a reference object as a reference image;
a feature point extracting means for extracting a plurality of feature points represented by information of position, scale, direction, and a local feature value, from each of the object image and the reference image;
a tentative corresponding point determining means for comparing the local feature values of the feature points between the object image and the reference image, and determining a plurality of tentative corresponding points;
a voting means for, for a combination of a value of scale magnification between the feature points and a value of a rotation angle of a direction, voting an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction, for each of the tentative corresponding points, and generating a histogram representing voting values for the plurality of intersection points between the plurality of sections related to the scale magnification and the plurality of sections related to the rotation angle of the direction; and
a correct corresponding point determining means for determining correct corresponding points among the tentative corresponding points, based on the generated histogram.

An information processing method, according to another aspect of the present invention, is configured to include
acquiring an image obtained by capturing a face of an object as an object image;
acquiring an image obtained by capturing a face of a reference object as a reference image;
extracting a plurality of feature points represented by information of position, scale, direction, and a local feature value, from each of the object image and the reference image;
comparing the local feature values of the feature points between the object image and the reference image, and determining a plurality of tentative corresponding points;
for a combination of a value of scale magnification between the feature points and a value of a rotation angle of a direction, voting an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction, for each of the tentative corresponding points, and generating a histogram representing voting values for the plurality of intersection points between the plurality of sections related to the scale magnification and the plurality of sections related to the rotation angle of the direction; and
determining correct corresponding points among the tentative corresponding points, based on the generated histogram.

A computer-readable medium, according to another aspect of the present invention, is configured to store thereon a program for causing a computer to execute processing to:
acquire an image obtained by capturing a face of an object as an object image;
acquire an image obtained by capturing a face of a reference object as a reference image;
extract a plurality of feature points represented by information of position, scale, direction, and a local feature value, from each of the object image and the reference image;
compare the local feature values of the feature points between the object image and the reference image, and determine a plurality of tentative corresponding points;
for a combination of a value of scale magnification between the feature points and a value of a rotation angle of a direction, vote an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction, for each of the tentative corresponding points, and generate a histogram representing voting values for the plurality of intersection points between the plurality of sections related to the scale magnification and the plurality of sections related to the rotation angle of the direction; and
determine correct corresponding points among the tentative corresponding points, based on the generated histogram.

### Advantageous Effects of Invention

Since the present invention has the aforementioned configuration, the present invention is capable of removing incorrect corresponding points with a small amount of information processing.

### BRIEF DESCRIPTION OF DRAWINGS

FIG. 1 is a block diagram of an information processing apparatus according to a first example embodiment of the present invention.

FIG. 2 is a diagram illustrating an example of information stored in a product database according to the first example embodiment of the present invention.

FIG. 3 is a schematic diagram illustrating an example of a two-dimensional histogram generated by a voting unit according to the first example embodiment of the present invention.

FIG. 4 is a flowchart illustrating an example of operation by the information processing apparatus according to the first example embodiment of the present invention.

FIG. 5 is a diagram illustrating a method of calculating a degree of non-rigid deformation in an information processing apparatus according to a second example embodiment of the present invention.

FIG. 6 is a schematic diagram illustrating another example of a two-dimensional histogram generated by a voting unit according to the second example embodiment of the present invention.

FIG. 7 is a flowchart illustrating an example of operation by the information processing apparatus according to the second example embodiment of the present invention.

FIG. 8 is a block diagram of an information processing apparatus according to a third example embodiment of the present invention.

FIG. 9 is a flowchart illustrating an example of operation by the information processing apparatus according to the third example embodiment of the present invention.

FIG. 10 is a block diagram of an information processing apparatus according to a fourth example embodiment of the present invention.

### EXAMPLE EMBODIMENT

Embodiments of the present invention will be described in detail with reference to the drawings.

### First Example Embodiment

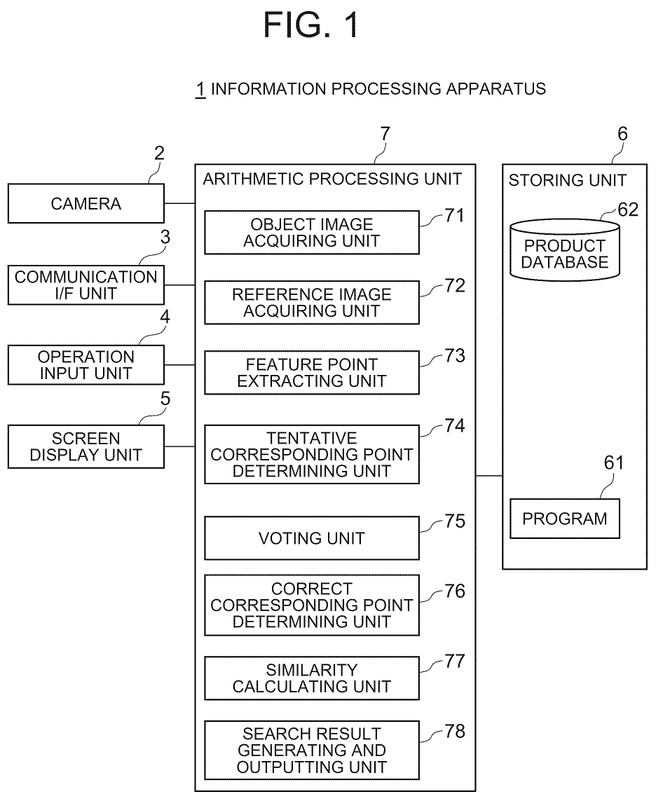

FIG. 1 is a block diagram of an information processing apparatus 1 according to a first example embodiment of the present invention. The information processing apparatus 1 is a portable information processing apparatus such as a smartphone, and has a function of searching a product database based on images obtained by capturing a product. Hereinafter, the product is assumed to be a pharmaceutical product package. In addition, it is assumed that a pharmaceutical product package is an external container or external envelope in which the primary packaging that comes into direct contact with the pharmaceutical product is further packaged for retail purposes, and its outer shape is assumed to be a rectangular parallelepiped. In addition, a surface (plane) on which the pharmaceutical name (product name) is displayed in large size is assumed to be the front of the pharmaceutical product package, and its shape is rectangular. However, the present invention is not limited to a pharmaceutical product package. The present invention is applicable to objects such as goods other than pharmaceutical product packages.

Referring to FIG. 1, the information processing apparatus 1 is configured with a camera 2, a communication I/F unit 3, an operation input unit 4, a screen display unit 5, a storing unit 6, and an arithmetic processing unit 7.

The camera 2 is, for example, a color camera or a black and white camera each including a Charge-Coupled Device (CCD) image-sensor or a Complementary MOS (CMOS) image-sensor having a pixel capacity of about several million pixels. The communication I/F unit 3 is configured with a data communication circuit and performs data communication with various external devices in a wireless or wired manner. The operation input unit 4 is configured with devices such as a keyboard and a mouse, and detects an operation by a user of the information processing apparatus 1 and outputs it to the arithmetic processing unit 7. The screen display unit 5 is configured with a device such as a liquid crystal display (LCD), and displays on a screen various types of information in accordance with an instruction from the arithmetic processing unit 7.

The storing unit 6 is configured with one or a plurality of storage devices such as a hard disk and a memory, and stores therein processing information and a program 61 necessary for various types of processing performed by the arithmetic processing unit 7. The program 61 is a program that realizes various processing units by the arithmetic processing unit 7 reading into and executing it, and is loaded in advance from an external device or a recording medium that is not illustrated via a data input/output function such as the communication I/F unit 3 and is stored in the storing unit 6. The main processing information stored in the storing unit 6 includes a product database 62.

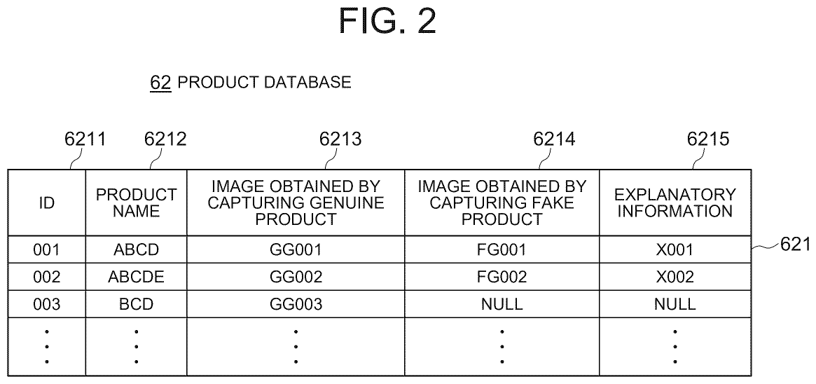

The product database 62 is a database in which various types of information on the product is accumulated. FIG. 2 is a diagram illustrating an example of information stored in the product database 62. The product database 62 of this example is configured with a plurality of pieces of product information 621. Each piece of product information 621 is configured with an ID 6211, a product name 6212, an image 6213 obtained by capturing a genuine product, an image 6214 obtained by capturing a fake product, and explanatory information 6215.

An ID such as a number that uniquely identifies the product information 621 is set in the entry of the ID 6211. The product name of an authentic product is set in the entry of the product name 6212. An image of the front of an authentic product captured from the right front is set in the entry of the image 6213 obtained by capturing a genuine product. An image of the front of a fake product captured from the right front is set in the entry of the image 6214 obtained by capturing a fake product. In the entry of the explanatory information 6215, a figure and/or text explaining the key points for distinguishing between the image 6213 obtained by capturing a genuine product and the image 6214 obtained by capturing a fake product are set.

The arithmetic processing unit 7 includes one or a plurality of processors such as a CPU (Central Processing Unit) and peripheral circuits thereof, and reads the program 61 from the storing unit 6 and executes it, thereby making the above hardware and the program 61 to cooperate and realizing various processing units. The main processing units realized by the arithmetic processing unit 7 are an object image acquiring unit 71, a reference image acquiring unit 72, a feature point extracting unit 73, a tentative corresponding point determining unit 74, a voting unit 75, a correct corresponding point determining unit 76, a similarity calculating unit 77, and a search result generating and outputting unit 78.

The object image acquiring unit 71 is configured to acquire, from the camera 2, an image obtained by capturing the front of a product as an object image. For example, when a user performs an operation of capturing the front of a product to be purchased with the camera 2 as a subject, the object image acquiring unit 71 acquires an image of the front of the product captured by the camera 2 as an object image. In addition to the front of the product, a side and the background of the product may be captured in the image captured by the camera 2. The object image acquiring unit 71 extracts the front image of the product as the object image from the image captured by the camera 2 by means of any method.

The reference image acquiring unit 72 is configured to read entire product information 621 from the product database 62, and acquire the image 6213 obtained by capturing a genuine product and the image 6214 obtained by capturing a fake product as independent reference images respectively, from the product information 621. The reference image acquiring unit 72 uniquely manages the individual reference image by assigning a branch number to the ID 6211 of the product information 621 as an image number. For example, in the case where the ID 6211 of the product information 621 is “001”, an image number “001-01” is given to the image 6213 obtained by capturing a genuine product included in the product information 21, and an image number “001-02” is given to the image 6214 obtained by capturing a fake product.

The feature point extracting unit 73 is configured to extract a plurality of feature points represented by the information of position, scale, direction, and a local feature value, from each of the object image acquired by the object image acquiring unit 71 and the reference image acquired by the reference image acquiring unit 72. For example, the feature point extracting unit 73 may extract a plurality of feature points represented by the information of position, scale, direction, and a local feature value from each of the object image and the reference image by performing processing of the Scale-Invariant Feature Transform (SIFT) algorithm. However, a plurality of feature points represented by the information of position, scale, direction, and a local feature value may be extracted by performing processing of other algorithms such as Oriented FAST and Rotated BRIEF (ORB) without being limited to SIFT. The feature point extracting unit 73 assigns a feature point number to individual feature point extracted from the object image and the reference image, and stores the information of position, scale, direction, and a local feature value in association with the feature point number. For example, the feature point extracting unit 73 uniquely manages individual feature point by assigning a branch number to the image number described above as a feature point number. For example, a feature point number such as “001-01-001” is given to each of the feature points extracted from the image of the image number “001-01”.

The tentative corresponding point determining unit 74 is configured to determine, for each pair of the object image and the reference image, a plurality of tentative corresponding points by comparison between local feature values of feature points of the object image and the reference image extracted by the feature point extracting unit 73. For example, for each feature point of the object image, the tentative corresponding point determining unit 74 calculates the Euclidean distance between the local feature values of the feature point and all feature points of the reference image, and detects the feature points with the smallest Euclidean distance as tentative corresponding points. However, the method of determining the tentative corresponding points is not limited to that described above, and any method may be used. The tentative corresponding point determining unit 74 stores the determined list of tentative corresponding points for each pair of the object image and the reference image. The tentative corresponding points are identified by, for example, a pair of feature point numbers. Further, the list of tentative corresponding points is, for example, a list of pairs of feature point numbers.

The voting unit 75 is configured to perform voting processing to generate a two-dimensional histogram for each pair of the object image and the reference image.

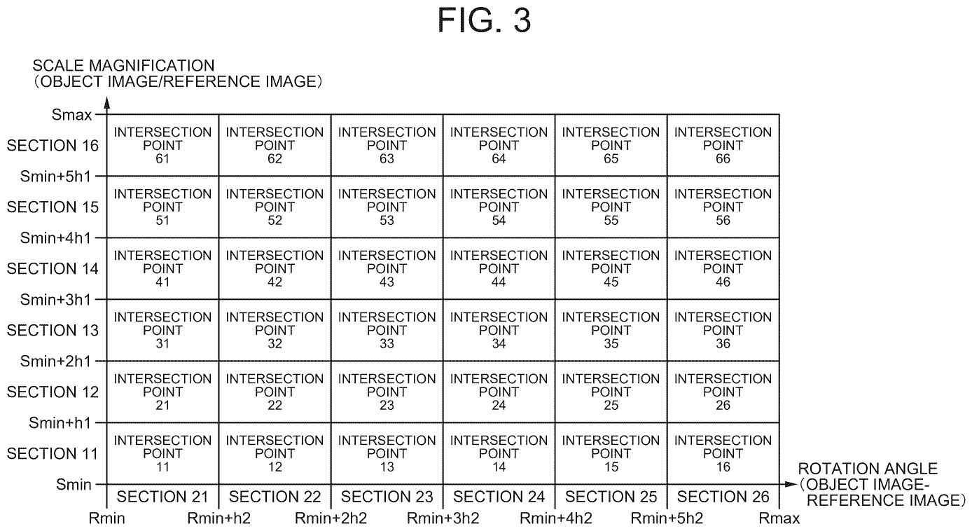

FIG. 3 is a schematic diagram illustrating an example of a two-dimensional histogram generated by the voting unit 75. In the two-dimensional histogram of this example, a plurality of sections related to the scale magnification are assigned to the vertical axis, and a plurality of sections related to the rotation angle of the direction are assigned to the horizontal axis. Here, the scale magnification is, for example, a rate of the scale of the feature point of the object image with respect to the scale of the feature point of the reference image constituting the tentative corresponding points. Further, the rotation angle is, for example, an angle obtained by subtracting the direction of the feature point of the reference image from the direction of the feature point of the object image constituting the tentative corresponding points. In addition, a value range is defined for each of the sections assigned to the vertical axis and the horizontal axis. For example, the minimum value and the maximum value of the scale magnification values are represented as Smin and Smax, the width of the scale section is represented as h1, the minimum value and the maximum value of the rotation angle values are represented as Rmin and Rmax, and the width of the rotation angle is represented as h2. Here, for example, the value ranges of a plurality of sections assigned to the vertical axis is represented as follows: the value range of section 11=Smin or larger, smaller than Smin+h1, section 12=Smin +h1 or larger, smaller than Smin+2h1, . . . , in order from the one closer to the minimum value Smin. In addition, for example, the value ranges of a plurality of sections assigned to the horizontal axis are represented as follows: the value range of section 21=Rmin or larger, smaller than Rmin+h2, section 22=Rmin+h2 or larger, smaller than Rmin+2h2, . . . , in order from the one closer to the minimum value Rmin.

Further, the two-dimensional histogram illustrated in FIG. 3 includes a plurality of intersection points designated by the sections assigned to the vertical axis and the sections assigned to the horizontal axis. For example, when the total number of sections assigned to the vertical axis is represented as k1 and the total number of sections assigned to the horizontal axis is represented as k2, there are k1×k2 pieces of intersection points in total. Each of the intersection points has a counter that counts the voting value and a storage area that stores information (feature point number pair) identifying the tentative corresponding points for which vote is made to the intersection point. The initial value of the counter and storage area is a NULL value.

The method of determining the total numbers k1 and k2 of the sections and the widths h1 and h2 of the sections is arbitrary. In general, Sturges' formula, Scott's choice, Friedman's choice, and other methods are known to determine the number and width of sections in histograms. These known methods or modifications thereof may be used.

The voting unit 75 performs the voting process as described below on the two-dimensional histogram for each pair of the object image and the reference image. First, the voting unit 75 pays attention to a pair of tentative corresponding points among all tentative corresponding points determined by the tentative corresponding point determining unit 74 for the pair. Then, with respect to the focused tentative corresponding points, the voting unit 75 determines an intersection point between a section related to the scale magnification in which the value of the scale magnification between the feature points is included in the value range and a section related to the rotation angle in which the value of the rotation angle in the direction between the feature points is included in the value range, and votes the intersection point. That is to say, the counter corresponding to the intersection point is incremented, and the information of the tentative corresponding points (a pair of feature point numbers) is stored in the storage area corresponding to the intersection point. Then, the voting unit 75 shifts its attention to the following pair of tentative corresponding points, and performs the same process as described above. When finishing paying attention to all of the tentative corresponding points determined by the tentative corresponding point determining unit 74 for the pair, the voting unit 75 stores the generated two-dimensional histogram in association with the pair. The voting unit 75 repeats the same process for the other pairs. Consequently, a two-dimensional histogram is generated for each pair of the object image and the reference image.

The correct corresponding point determining unit 76 is configured to determine correct corresponding points based on the intersection point at which the voting value is maximum, for each two-dimensional histogram generated by the voting unit 75. For example, the correct corresponding point determining unit 76 compares values of the counters of respective intersection points of the two-dimensional histogram, and determines the intersection point of the counter that takes the maximum value. Then, the correct corresponding point determining unit 76 determines a set of tentative corresponding points specified by the list of feature point numbers stored in the storage area of the determined intersection point to be a set of correct corresponding points. The reason for the determination in this manner is that, when the front of the same product is shown in the object image and the reference image, the scale magnification and the rotation angle of the direction of the corresponding points are often similar.

The similarity calculating unit 77 is configured to calculate the number of tentative corresponding points included in the set of correct corresponding points determined by the correct corresponding point determining unit 76 from the two-dimensional histogram generated for each pair of the object image and the reference image, as the degree of similarity of the pair of the object image and the reference image.

The search result generating and outputting unit 78 is configured to select a maximum degree of similarity among the degrees of similarity of the pairs of the object images and the reference images calculated by the similarity calculating unit 77, and determine a reference image having the selected degree of similarity to be a reference image similar to the object image. Alternatively, the search result generating and outputting unit 78 may determine a reference image having a degree of similarity equal to or larger than a threshold from among the degrees of similarity of the respective pairs of the object images and the reference images calculated by the similarity calculating unit 77 to be a reference image similar to the object image. Moreover, the search result generating and outputting unit 78 reads the product information 621 including the determined reference image as the image 6213 obtained by capturing a genuine product or the image 6214 obtained by capturing a fake product, from the product database 62. Furthermore, the search result generating and outputting unit 78 displays the readout product information 621 as a search result on the screen display unit 5, or/and transmits it to an external device via the communication I/F unit 3.

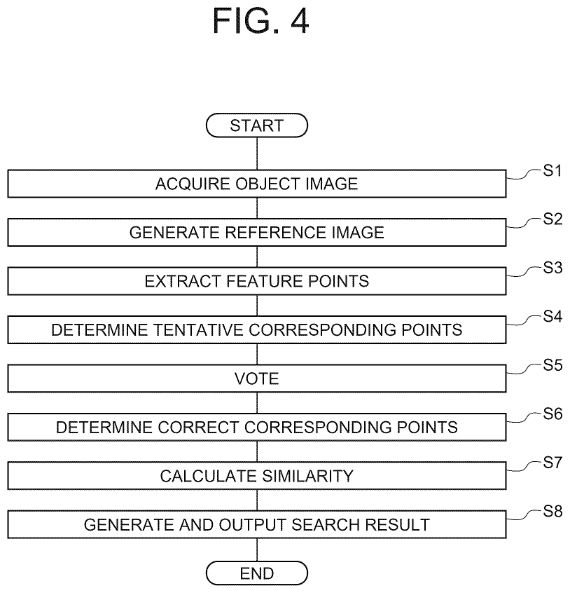

FIG. 4 is a flowchart illustrating an example of operation of the information processing apparatus 1. Hereinafter, operation of the information processing apparatus 1 will be described with reference to FIG. 4

First, the object image acquiring unit 71 acquires, from the camera 2, an image obtained by capturing the front of a product as an object image (step S1). Next, the reference image acquiring unit 72 reads every product information 621 from the product database 62, and acquires the image 6213 obtained by capturing a genuine product and the image 6214 obtained by capturing a fake product from the product information 621, as reference images (step S2). Next, the feature point extracting unit 73 extracts a plurality of feature points represented by information of position, scale, direction, and a local feature value from each of the object image acquired by the object image acquiring unit 71 and the reference image acquired by the reference image acquiring unit 72 (step S3).

Next, for each pair of the object image and the reference image, the tentative corresponding point determining unit 74 compares local feature values of the respective feature points between the object image and the reference image extracted by the feature point extracting unit 73 to determine a plurality of tentative corresponding points (step S4). Next, the voting unit 75 performs a voting process to generate a two-dimensional histogram for each pair of the object image and the reference image (step S5). In the voting process described above, for each of the tentative corresponding points, the voting unit 75 votes an intersection point corresponding to a combination of a section related to the scale magnification and a section related to the rotation angle of the direction, corresponding to a combination of a value of the scale magnification between the feature points and a value of the rotation angle of the direction. As a result, two-dimensional histograms representing voting values for the intersection points between the plurality of sections related the scale magnification and the plurality of sections related to the rotation angle of the direction are generated.

Next, for each two-dimensional histogram generated by the voting unit 75, the correct corresponding point determining unit 76 determines correct corresponding points based on the intersection point at which the voting value is maximum (step S6). Next, the similarity calculating unit 77 calculates the number of tentative corresponding points included in the set of correct corresponding points determined by the correct corresponding point determining unit 76 from the two-dimensional histogram generated for each pair of the object image and the reference image, as the degree of similarity of the pair of the object image and the reference image (step S7).

Next, the search result generating and outputting unit 78 generates and outputs a search result (step S8). In generating the search result, the search result generating and outputting unit 78 first selects a maximum degree of similarity among the degrees of similarity of the respective pairs of the object images and the reference images calculated by the similarity calculating unit 77, and determines the reference image having the selected degree of similarity to be a reference image similar to the object image. Then, the search result generating and outputting unit 78 reads the product information 621 including the determined reference image as the image 6213 obtained by capturing a genuine product or the image 6214 obtained by capturing a fake product, from the product database 62. Further, in outputting the search result, the search result generating and outputting unit 78 displays the readout product information 621 on the screen display unit 5, or/and transmits it to an external device via the communication I/F unit 3.

As described above, according to the information processing apparatus 1, since the voting unit 75 and the correct corresponding point determining unit 76 that are configured and operate as described above are provided, incorrect corresponding points can be removed with a small amount of information processing, so that the amount of information processing necessary for image matching by searching for corresponding points can be reduced.

### Second Example Embodiment

Next, a second example embodiment of the present invention will be described. An information processing apparatus according to the second example embodiment (hereafter referred to as an information processing apparatus 1A) differs in the function of the voting unit 75 from the information processing apparatus 1 according to the first example embodiment, and is otherwise the same as the first example embodiment.

The voting unit 75 in the present embodiment is configured to calculate the degree of non-rigid deformation representing the degree of non-rigid deformation in the front of a product captured in an object image acquired by the object image acquiring unit 71. The front of a real product has a rectangular shape. However, the front of the product in an image obtained by shooting from an angle with the camera 2 is non-rigidly deformed and loses the rectangular shape. As compared with an object image having a rectangular shape, in an object image that does not have a rectangular shape, the degree of similarity in the scale magnification and the rotation angle of the direction of the corresponding points, when the same product is captured in the reference image, is lowered. The tendency of lowering is more prominent as the degree of non-rigid deformation increases. In other words, the closer the surface of the product in the object image is to the rectangular shape, the higher the degree of similarity in the scale magnification and the rotation angle in the direction of the corresponding points when the same product is captured in the reference image.

Therefore, the voting unit 75 in the present embodiment is configured to generate, by voting, a two-dimensional histogram of a type corresponding to the calculated degree of non-rigid deformation, among a plurality of types of two-dimensional histograms in which the value ranges of the plurality of sections on the scale magnification and the value ranges of the plurality of sections on the rotation angle of the direction are different respectively.

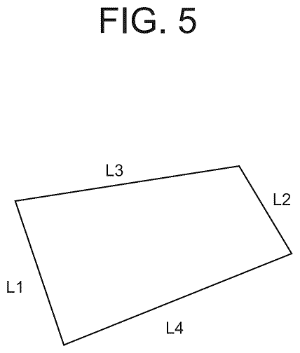

FIG. 5 is a diagram illustrating an example of a method of calculating the degree of non-rigid deformation. The rectangle illustrated in FIG. 5 is configured with four sides L1 to L4, with the sides L1 and L2 facing each other, and the sides L3 and L4 facing each other. The voting unit 75 extracts the four sides constituting the front of the product shown in the object image, calculates a rate of the long side to the short side for each pair of opposite sides, and sets the greater rate as the degree of non-rigid deformation of the front. For example, in the rectangle illustrated in FIG. 5, if L1/L2=1.3 and L3/L4=1.1, the degree of non-rigid deformation is set to 1.3. However, the method of calculating the degree of non-rigid deformation is not limited to the above. Any indicator may be used as the degree of non-rigid deformation as long as the indicator indicates the degree of not being rectangle.

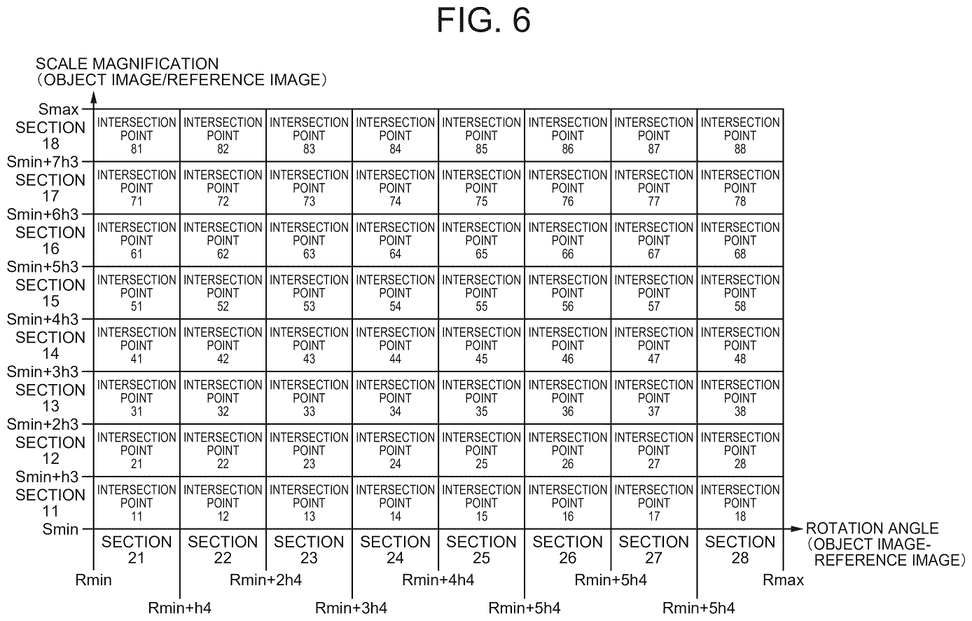

FIG. 6 is a schematic diagram illustrating another example of a two-dimensional histogram generated by the voting unit 75. As compared with the two-dimensional histogram illustrated in FIG. 3, the two-dimensional histogram illustrated in FIG. 6 differs in that the width of the section of the scale is h3 that is smaller than h1 and the width of the rotation angle is h4 that is smaller than h2. The minimum value Smin and the maximum value Smax of the scale magnification values and the minimum value Rmin and the maximum value Rmax of the rotation angle values are the same as those in FIG. 3. Therefore, the two-dimensional histogram illustrated in FIG. 6 has a larger total number of sections on the vertical axis and the horizontal axis, as compared with the two-dimensional histogram illustrated in FIG. 3.

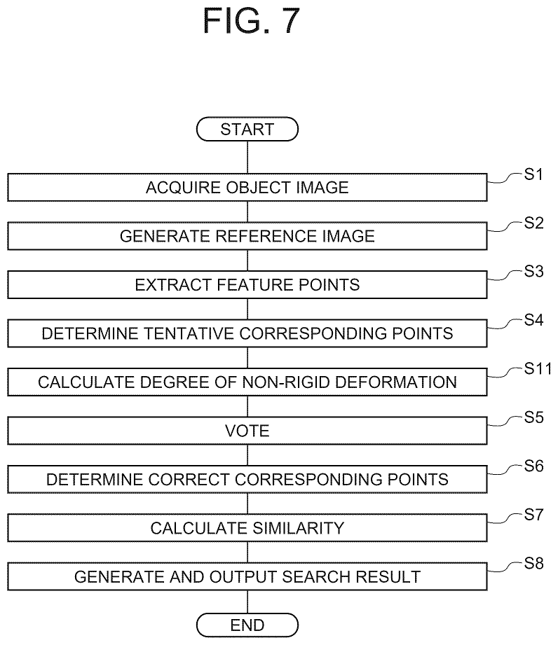

Next, operation of the present embodiment will be described with reference to the flow chart illustrated in FIG. 7.

The processes from step S1 to step S4 are the same as the processes from step S1 to step S4 illustrated in FIG. 4. In step S11, the voting unit 75 calculates the degree of non-rigid deformation representing the degree of non-rigid deformation in the front of the product captured in the object image acquired by the object image acquiring unit 71. Then, in step S5, when the calculated degree of non-rigid deformation is less than a threshold T in the two types of two-dimensional histograms illustrated in FIGS. 3 and 6, the voting unit 75 generates the two-dimensional histogram illustrated in FIG. 6 with the narrower width of the section by voting. On the other hand, when the calculated degree of non-rigid deformation is equal to or higher than the threshold T, the voting unit 75 generates the two-dimensional histogram illustrated in FIG. 3 with the wider width of the section by voting in step S5. The subsequent processes from step S6 to step S8 are the same as those in the first example embodiment.

In the above description, two types of two-dimensional histograms have been used in which the value ranges of a plurality of sections on the scale magnification and the value ranges of a plurality of sections on the rotation angle of the direction are different, respectively, but three or more types of two-dimensional histograms may be used.

According to the present example embodiment as described above, among a plurality of types of two-dimensional histograms in which the value ranges of the plurality of sections on the scale magnification and the value ranges of the plurality of sections on the rotation angle of the direction are different, a two-dimensional histogram of the type according to the degree of non-rigid deformation in the front of the product shown in the object image is generated by voting.

Therefore, with respect to the object image obtained by capturing the front of a product from the right front by the user, a two-dimensional histogram with a narrower value range of the section can be generated by voting, and it is possible to increase the proportion of truly correct corresponding points in the set of correct corresponding points by fully utilizing the characteristics that when the same product is captured in the object image and the reference image, the scale magnification and the rotation angle of the direction of corresponding points are often similar. The reason for this is that in a two-dimensional histogram with a wider value range of the section, the probability of an incorrect correspondence point being voted at the intersection point with the largest voting value is increased. On the other hand, with respect to an object image obtained by capturing the front of a product from an angle by a user, a two-dimensional histogram with a wider value range of the section can be generated by voting, so that the probability that correct corresponding points are removed from the set of correct corresponding points can be reduced. In addition, in the case where the same product is shown in the object image and the reference image, the probability of incorrect corresponding points being voted at the intersection point with the largest vote value increases in a two-dimensional histogram with a wide value range of the section, but beyond that, since the probability of correct corresponding points being removed from the set of correct corresponding points decreases, it is possible to prevent an extreme decrease in the accuracy of similarity.

### Third Example Embodiment

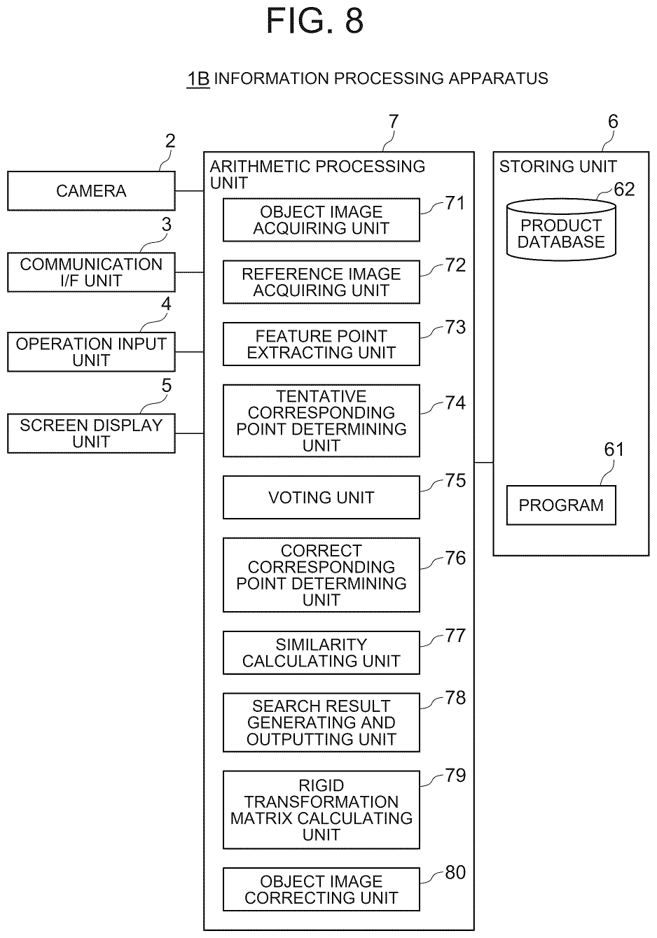

Next, a third example embodiment of the present invention will be described. FIG. 8 is a block diagram of an information processing apparatus 1B according to a third example embodiment of the present invention. In the drawing, the same reference signs as those in FIG. 1 denote the same parts, a reference numeral 79 denotes a rigid transformation matrix calculating unit, and a reference numeral 80 denotes an object image correcting unit.

The rigid transformation matrix calculating unit 79 is configured to calculate a rigid transformation matrix between an object image and a reference image based on correct corresponding points determined by the correct corresponding point determining unit 76. Various methods have been proposed or put into practical use to calculate a rigid transformation matrix between two images from a plurality of corresponding points. Any method may be used.

The object image correcting unit 80 is configured to perform rigid transformation on an object image by using the rigid transformation matrix calculated by the rigid transformation matrix calculating unit 79.

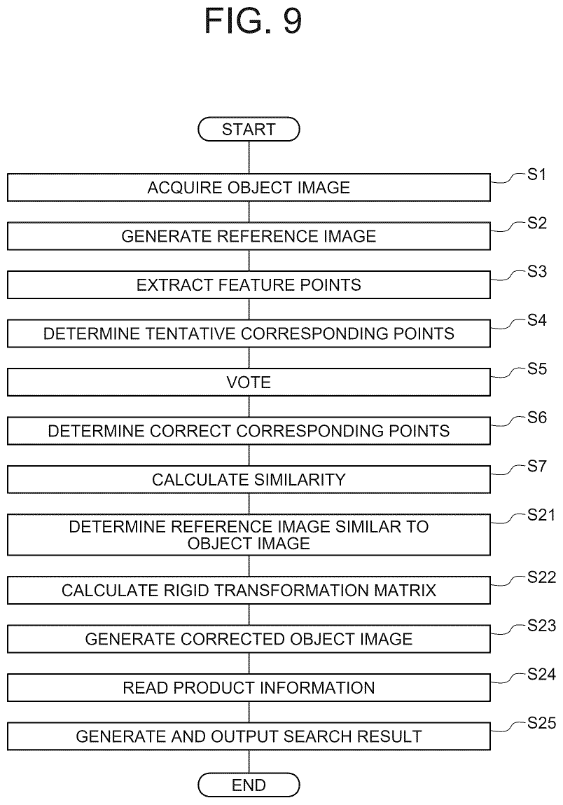

Next, operation of the present embodiment will be described with reference to the flow chart illustrated in FIG. 9.

The processes from step S1 to step S7 are the same as the processes from step S1 to step S7 in FIG. 4. Next, the search result generating and outputting unit 78 selects the maximum degree of similarity from among the degrees of similarity of the respective pairs of object images and reference images calculated by the similarity calculating unit 77, and determines a reference image having the selected degree of similarity to be a reference image similar to the object image (step S21). Next, the rigid transformation matrix calculating unit 79 calculates a rigid transformation matrix between the object image and the reference image based on the correct corresponding points between the object image and the reference image determined in step S21 (step S22). Next, the object image correcting unit 80 generates a corrected object image by performing rigid transformation on the object image by using the calculated rigid transformation matrix (step S23). Next, the search result generating and outputting unit 78 reads the product information 621 including the reference image determined in step S21 as the image 6213 obtained by capturing a genuine product or the image 6214 obtained by capturing a fake product, from the product database 62 (step S24). Then, the search result generating and outputting unit 78 displays, on the screen display unit 5, the corrected object image as a monitor image of the object image captured with the camera, and the readout product information 621 as a search result, or/and transmits them to an external device via the communication I/F unit 3 (step S25).

As described above, according to the present embodiment, the same effect as that of the first example embodiment can be achieved, and the object image taken by the user with the camera 2 can be displayed on the monitor as a corrected image. Therefore, for example, the size and orientation of the object image taken by the user can be adjusted to the reference image. As a result, the user can easily recognize the difference between the object image and an image such as a genuine product on the screen.

### Fourth Example Embodiment

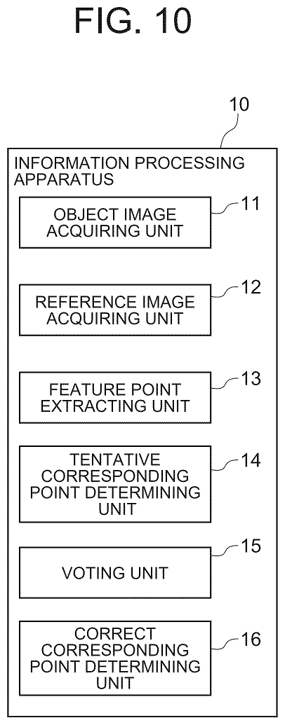

Next, a fourth example embodiment of the present invention will be described. FIG. 10 is a block diagram of an information processing apparatus 10 according to the present embodiment. The present embodiment describes the outline of the information processing apparatus described above.

As illustrated in FIG. 10, the information processing apparatus 10 of the present embodiment is configured with an object image acquiring unit 11, a reference image acquiring unit 12, a feature point extracting unit 13, a tentative corresponding point determining unit 14, a voting unit 15, and a correct corresponding point determining unit 16.

The object image acquiring unit 11 is configured to acquire an image obtained by capturing a face of an object as an object image. The reference image acquiring unit 12 is configured to acquire an image obtained by capturing a face of a reference object as a reference image. The feature point extracting unit 13 is configured to extract a plurality of feature points represented by information of position, scale, direction, and a local feature value, from each of the object image and the reference image. The tentative corresponding point determining unit 14 is configured to determine a plurality of tentative corresponding points by comparing local feature values of respective feature points between the object image and the reference image.

The voting unit 15 is configured to, for a combination of the value of the scale magnification between the feature points and the value of the rotation angle of the direction, vote an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction, for each of the tentative corresponding points, and generate a histogram representing voting values for a plurality of intersection points between the plurality of sections related to the scale magnification and the plurality of sections related to the rotation angle of the direction. The correct corresponding point determining unit 16 is configured to determine correct corresponding points among the tentative corresponding points based on the generated histogram.

The information processing apparatus 10 configured as described above operates as described below. First, the object image acquiring unit 11 acquires an image obtained by capturing a face of an object as an object image. Next, the reference image acquiring unit 12 acquires an image obtained by capturing a face of a reference object as a reference image. Next, the feature point extracting unit 13 extracts a plurality of feature points represented by the information of position, scale, direction, and a local feature value, from each of the object image and the reference image. Next, the tentative corresponding point determining unit 14 compares the local feature values of the respective feature points between the object image and the reference image to determine a plurality of tentative corresponding points. Next, for a combination of the value of the scale magnification between the feature points and the value of the rotation angle of the direction, the voting unit 15 votes an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction, for each of the tentative corresponding points, and generates a histogram representing the voting values for a plurality of intersection points between the plurality of sections related to the scale magnification and the plurality of sections related to the rotation angle of the direction. Next, the correct corresponding point determining unit 16 determines correct corresponding points among the tentative corresponding points based on the generated histogram.

According to the information processing apparatus 10 that is configured and operates as described above, since the voting unit 15 and the correct corresponding point determining unit 16 that are configured and operate as described above are provided, incorrect corresponding points can be deleted with a small amount of information processing.

Although the present invention has been described above with reference to the above example embodiments, the present invention is not limited to the example embodiments described above. The configuration and details of the present invention can be changed in various manners that can be understood by those skilled in the art within the scope of the present invention.

For example, in the above example, the voting unit votes one intersection point for each of the tentative corresponding points, but may vote at least one intersection point among an intersection point corresponding to a combination of the section corresponding to the value of the scale magnification and the section corresponding to the value of the rotation angle in the direction and at most eight surrounding intersection points in direct contact with it. Further, in the above example, the correct corresponding point determining unit calculates the degree of similarity based on the maximum voting value, but may calculate the degree of similarity based on a voting value equal to or larger than a threshold.

Moreover, the information processing apparatus may use a GPU (Graphic Processing Unit), a DSP (Digital Signal Processor), an MPU (Micro Processing Unit), an FPU (Floating number Processing Unit), a PPU (Physics Processing Unit), a TPU (Tensor Processing Unit), a quantum processor, a microcontroller, or a combination thereof, instead of the abovementioned CPU.

### INDUSTRIAL APPLICABILITY

The present invention is applicable to general image processing such as image matching using a local feature value.

### REFERENCE SIGNS LIST

1 information processing apparatus
2 camera
3 communication I/F unit
4 operation input unit
5 screen display unit
6 storing unit
7 arithmetic processing unit
10 information processing apparatus
11 object image acquiring unit
12 reference image acquiring unit
13 feature point extracting unit
14 tentative corresponding point determining unit
15 voting unit
16 correct corresponding point determining unit

What is claimed is:

1. An information processing apparatus comprising:
a memory containing program instructions; and
a processor coupled to the memory, wherein the processor is configured to execute the program instructions to:
acquire an image obtained by capturing a face of an object as an object image;
acquire an image obtained by capturing a face of a reference object as a reference image;
extract a plurality of feature points represented by information of position, scale, direction, and a local feature value, from each of the object image and the reference image;
for each combination of the object mage and the reference image, compare the local feature values of the feature points between the object image and the reference image, and determine a plurality of tentative corresponding points;
perform a voting process to generate a histogram for each combination of the object mage and the reference image, the generating the histogram including, with use of a histogram in an initial state and, for a combination of a value of scale magnification between the feature points and a value of the rotation angle of the direction, voting an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction in the histogram in the initial state, for each of the tentative corresponding points, and generate a histogram representing voting values for the plurality of intersection points between the plurality of sections related to the scale magnification and the plurality of sections related to the rotation angle of the direction; and
determine correct corresponding points among the tentative corresponding points, based on the generated histogram.

2. The information processing apparatus according to claim 1, wherein
the determining the correct corresponding points among the tentative corresponding points includes determining correct corresponding points among the tentative corresponding points on a basis of an intersection point between the plurality of sections in which the voting value is maximum.

3. The information processing apparatus according to claim 2, wherein the processor is further configured to execute the program instructions to
calculate a degree of non-rigid deformation representing a degree of non-rigid deformation of the surface from the object image, and
the generating the histogram uses a histogram of a type corresponding to the calculated degree of non-rigid deformation among a plurality of types of histograms in the initial state in which value ranges of the plurality of sections related to the scale magnification and value ranges of the plurality of sections related to the rotation angle of the direction are different depending on the plurality of types.

4. The information processing apparatus according to claim 2, wherein the processor is further configured to execute the program instructions to,
calculate a degree of similarity between the object image and the the reference image on a basis of a number of the determined correct corresponding points.

5. The information processing apparatus according to claim 2, wherein the processor is further configured to execute the program instructions to
calculate a rigid transformation matrix between the object image and the reference image on a basis of the determined correct corresponding points.

6. The information processing apparatus according to claim 5,—wherein the processor is further configured to execute the program instructions to
perform rigid transformation on the object image by using the calculated rigid transformation matrix.

7. An information processing method comprising:
acquiring an image obtained by capturing a face of an object as an object image;
acquiring an image obtained by capturing a face of a reference object as a reference image;
extracting a plurality of feature points represented by information of position, scale, direction, and a local feature value, from each of the object image and the reference image;
for each combination of the object mage and the reference image, comparing the local feature values of the feature points between the object image and the reference image, and determining a plurality of tentative corresponding points;
performing a voting process to generate a histogram for each combination of the object mage and the reference image, the generating the histogram including, with use of a histogram in an initial state, for a combination of a value of scale magnification between the feature points and a value of a rotation angle of a direction, voting an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction in the histogram in the initial state, for each of the tentative corresponding points, and generating a histogram representing voting values for the plurality of intersection points between the plurality of sections related to the scale magnification and the plurality of sections related to the rotation angle of the direction; and
determining correct corresponding points among the tentative corresponding points, based on the generated histogram.

8. The information processing method according to claim 7, wherein
the determining the correct corresponding points includes determining correct corresponding points among the tentative corresponding points on a basis of an intersection point between of the plurality of sections in which the voting value is maximum.

9. The information processing method according to claim 8, wherein
the processor is further configured to execute the program instructions to
calculate a degree of non-rigid deformation representing a degree of non-rigid deformation of the surface from the object image, and
the generating the histogram includes using a histogram of a type corresponding to the calculated degree of non-rigid deformation among a plurality of types of histograms in the initial state in which value ranges of the plurality of sections related to the scale magnification and value ranges of the plurality of sections related to the rotation angle of the direction are different depending on the plurality of types.

10. The information processing method according to claim 8, wherein the processor is further configured to execute the program instructions to
calculate a degree of similarity between the object image and the reference image on a basis of a number of the determined correct corresponding points.

11. The information processing method according to claim 8, wherein the processor is further configured to execute the program instructions to
calculate a rigid transformation matrix between the object image and the reference image on a basis of the determined correct corresponding points.

12. The information processing method according to claim 11, wherein the processor is further configured to execute the program instructions to
perform rigid transformation on the object image by using the calculated rigid transformation matrix.

13. A non-transitory computer-readable medium storing thereon a program comprising instructions for causing a computer to execute processing to:
acquire an image obtained by capturing a face of an object as an object image;
acquire an image obtained by capturing a face of a reference object as a reference image;
extract a plurality of feature points represented by information of position, scale, direction, and a local feature value, from each of the object image and the reference image;
for each combination of the object image and the reference image, compare the local feature values of the feature points between the object image and the reference image, and determine a plurality of tentative corresponding points;
perform a voting process to generate a histogram for each combination of the object mage and the reference image, the generating the histogram including, with use of a histogram in an initial state, for a combination of a value of scale magnification between the feature points and a value of a rotation angle of a direction, vote an intersection point corresponding to a combination of a section corresponding to the value of the scale magnification and a section corresponding to the value of the rotation angle of the direction among a plurality of intersection points specified by combinations of a plurality of sections related to the scale magnification and a plurality of sections related to the rotation angle of the direction in the histogram in the initial state, for each of the tentative corresponding points, and generate a histogram representing voting values for the plurality of intersection points between the plurality of sections related to the scale magnification and the plurality of sections related to the rotation angle of the direction; and
determine correct corresponding points among the tentative corresponding points, based on the generated histogram.
